(19) United States
(12) Patent Application Publication
(10) Pub. No.: US 2011/0239139 A1
(43) Pub. Date: Sep. 29, 2011

(54) REMOTE CONTROL APPARATUS USING MENU MARKUP LANGUAGE

(75) Inventors: Dongwoo Lee, Daejeon-city (KR); Jeongmook Lim, Daejeon-city (KR); Hyuntae Jeong, Daejeon-city (KR); Gague Kim, Daejeon-city (KR); John Sunwoo, Daejeon-city (KR); Jieun Kim, Daejeon-city (KR); Ilyeon Cho, Daejeon-city (KR); Yongki Son, Daejeon-city (KR); Hyungsun Lee, Daejeon-city (KR); Baesun Kim, Daejeon-city (KR)

(73) Assignee: Electronics and Telecommunications Research Institute, Daejeon (KR)

(21) Appl. No.: 13/120,910

(22) PCT Filed: Sep. 29, 2009
(86) PCT No.: PCT/KR2009/005560

§ 371 Date: Apr. 28, 2011

(30) Foreign Application Priority Data
Oct. 7, 2008 (KR) 10-2008-0098213

(51) Int. Cl. G06F 3/01

(52) U.S. Cl. 715/760

(57) ABSTRACT

Provided is a remote control apparatus using a menu markup language, which arranges, within an area, a virtual menu map for controlling electronic devices from menu map information that is defined by a menu markup language (MenuXml) having an extensible markup language (XML) format, extracts control information corresponding to motion information of a user generated within the area from the menu map information, and transmits the extracted control information to the electronic devices.

### TECHNICAL FIELD

The present invention relates to a remote control apparatus using a menu markup language, and more particularly, to a remote control apparatus that uses a menu markup language so as to control electronic devices according to motion information of a user by implementing a virtual menu map based on menu map information defined by a menu markup language.

### BACKGROUND ART

Generally, as a representative remote control technology used for electronic devices, a remote controller with a built-in infrared transmitter is used. The remote controller is provided with various buttons, such as a volume control button, a channel change button, a power supply on/off button, and the like, each of which has only one function. Therefore, if any one of the buttons on the remote controller is operated, an infrared signal of the corresponding function is transmitted and the corresponding electronic device receives and processes the transmitted infrared signal.

As the number of electronic devices that exist in one space such as a home or an office and the like increases, a technology capable of controlling all the electronic devices using one remote controller has been developed. Further, more electronic devices will exist in the near future than the present age in a ubiquitous environment. Therefore, due to the ubiquitous environment, a technology to control the electronic devices using a user-friendly interface with one remote control apparatus will be in demand.

However, since each of the electronic devices of the related art has functions meeting a remote control apparatus, in order to control the electronic devices using one remote control apparatus, the remote control apparatus should have functions meeting each of the electronic devices.

Recently, instead of the remote controller, a technology capable of controlling electronic devices using biological signals of a user has been introduced. Therefore, in order to control the electronic devices having various functions by using the biological signals such as a user-friendly hand motion rather than the remote controller, appropriate menu functions the biological signals should be implemented.

### DISCLOSURE OF INVENTION

Technical Problem menu markup language so as to implement a virtual menu map that can be controlled according to biological signals of a user based on menu map information defined by a menu markup language.

Further, it is another object of the present invention to provide a remote control apparatus using a markup language facilitating menu implementation by designing a virtual menu map using a menu markup language based on an extensible markup language

### Solution to Problem

In order to achieve the above objects, there is provided a remote control apparatus using a menu markup language according to the present invention, wherein the remote control apparatus arranges a virtual menu map for controlling electronic devices within an area and transmits control information corresponding to motion information of a user generated within an area of the electronic devices, the remote control apparatus comprising: a menu map information storing unit that stores a menu map information defined by a menu markup language (Menu XML) in an extensible markup language (XML) format; and a menu map implementing unit that implements the virtual menu map according to the menu map information stored in the menu map information storing unit, extracts control information corresponding to the motion information of the user from the menu map information, and transmits the extracted control information to the electronic devices. At this time, the motion information of the user is hand motion information of the user.

The menu map markup language includes a route element ‘menuxml’ defined to inquiry the electronic devices. Further, the menu markup language further comprises elements that define the corresponding electronic devices, wherein the elements defining the electronic devices includes id attribute, name attribute, and model attribute regarding the corresponding electronic devices. Also, the menu markup language further comprises elements defining menus regarding the corresponding electronic devices, wherein the elements defining the menus includes id attribute, title attribute, type attribute, default attribute, and parent attribute regarding the corresponding menus.

In addition, the menu markup language further comprises elements defining menu buttons configuring the corresponding menus, wherein the elements defining the menu buttons includes at least one of index attribute indicating a position, id attribute, and text attribute indicating button description regarding the corresponding menu buttons. Meanwhile, the elements defining the menu button further comprises attribute for controlling the corresponding menu buttons according to the motion information of the user, wherein the attribute for controlling the menu buttons is at least one of recursive attribute, skip attribute, and nomoveout attribute.

Moreover, the menu markup language defines an event attribute according to the motion information of the user, wherein the event attribute is at least one of onload, onclick, onleft, onright, onup, ondown, onspinleft, and onspinright.

On the other hand, in order to achieve the above objects, the present invention comprises a recording medium that records a program for running a virtual menu map implemented according to menu map information defined by a menu markup language using a computer.

### Advantageous Effects of Invention

With the present invention, the virtual menu map, which is implemented based on the menu map information defined by the menu markup language, is used as the interface for controlling the electronic devices, such that it is easy to control the electronic device using the biological signals of the user such as the hand motion.

Further, the menu map information according to the present invention is configured of an upper menu and a lower menu to easily determine a structure according to the menu map configuration.

Also, the menu is designed using the menu markup language based on the extensible markup language, such that it is easy to facilitate a menu design that can be applied to the electronic devices.

### BRIEF DESCRIPTION OF DRAWINGS

FIG. 1 is a diagram showing a system configuration to which a remote control apparatus using a menu markup language according to the present invention is applied;

FIG. 2 is a block diagram for explaining a configuration of a remote control apparatus using a menu markup language according to the present invention;

FIGS. 3A to 3C are a diagram exemplifying a virtual menu map implemented by a remote control apparatus using a menu markup language according to the present invention; and

FIGS. 4 to 6 are diagrams exemplified for explaining embodiments of menu map information that is defined using a menu markup language according to the present invention.

### BEST MODE FOR CARRYING OUT THE INVENTION

Hereinafter, exemplary embodiment of the present invention will be described with reference to the accompanying drawings.

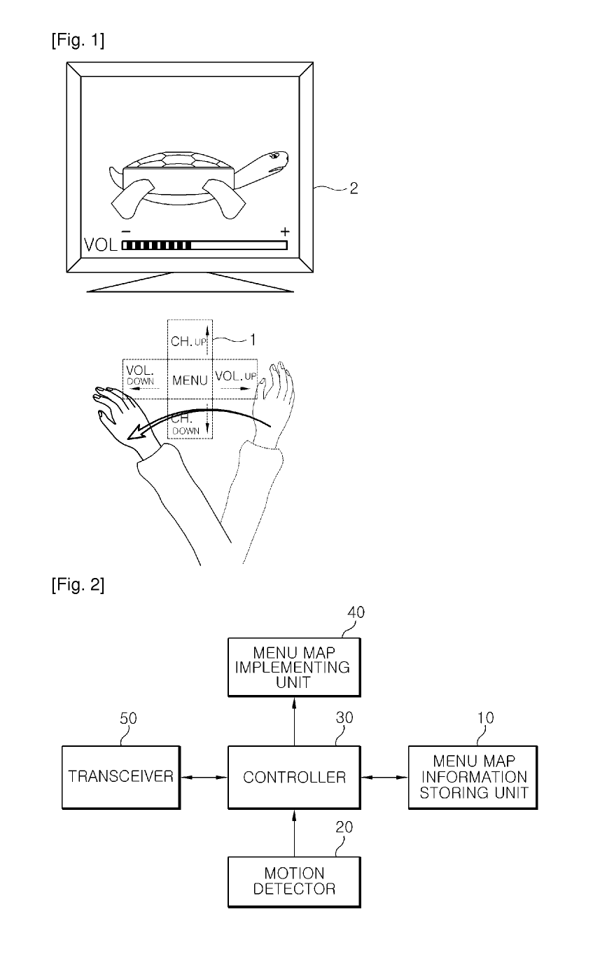

FIG. 1 is a diagram showing a system configuration to which a remote control apparatus using a menu markup language according to the present invention is applied.

As shown in FIG. 1, a remote control apparatus using a menu markup language according to the present invention arranges a virtual menu map 1 on a space based on menu map information defined by a menu markup language. At this time, a user controls buttons on the virtual menu map 1 from biological signals such as hand motion and the like by using the virtual menu map 1 arranged on the space. Herein, the menu markup language MenuXml is based on an extensible markup language (XML).

Events according to the motion information of the user and the corresponding control information, etc. is defined in the menu map information defined by the menu markup language, such that the corresponding menu button according to the motion information corresponding to the biological signals generated from the user is arranged through the virtual menu map 1. Herein, the virtual menu map 1 is actually a non-existing map, but may be implemented on an actual space using a hologram, etc.

Further, the remote control apparatus according to the present invention is connected with an electronic device 2 to extract the control information from the menu map information according to the motion information corresponding to the biological signal and transmit the extracted control information to the corresponding electronic device 2, if the biological signal from the user is generated.

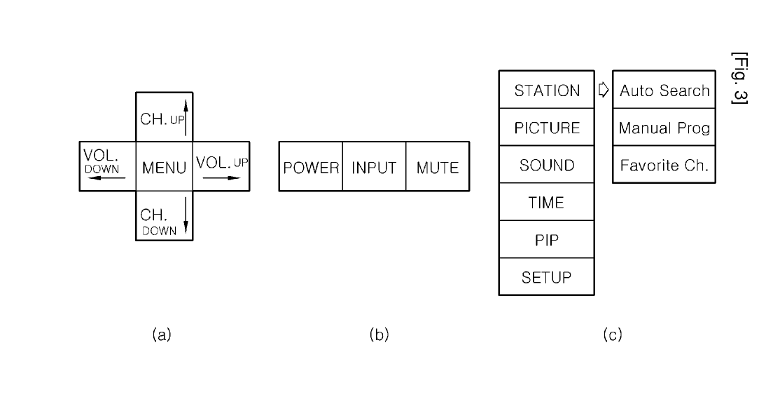

Hereinafter, a configuration of the remote control apparatus using the menu markup language according to the present invention will be described with reference to FIG. 2. The remote control apparatus using the menu markup language according to the present invention includes a menu map information storing unit 10, a motion detector 20, a controller 30, a menu map implementing unit 40, and a transceiver 50 as shown in FIG. 2.

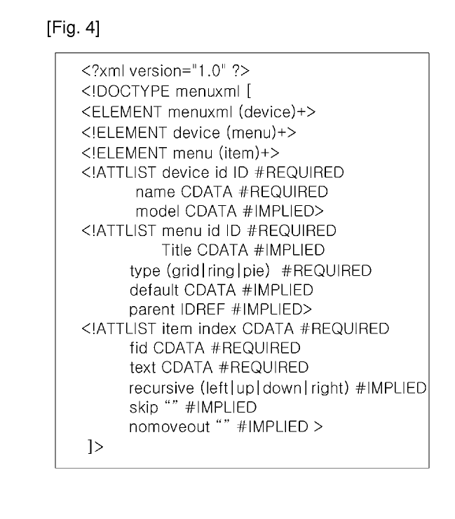

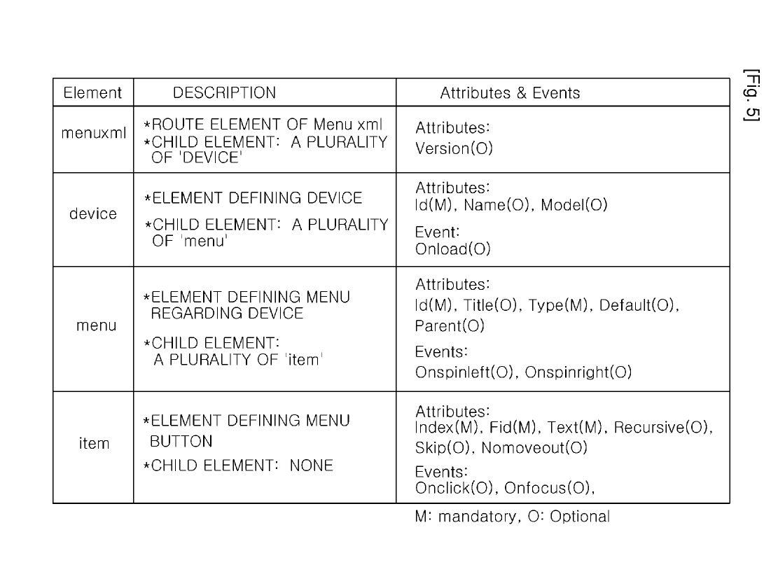

First, the menu map information storing unit 10 stores menu map information regarding the virtual menu map 1 implemented on the space. At this time, the menu map information is designed by a menu markup language based on an extensible markup language. Herein, the menu markup language includes route elements and child elements, the detailed description of which refers to a description of FIG. 4. The menu map information regarding the electronic device, which is recorded in each electronic device, can be provided from the corresponding electronic device while synchronization between the remote control apparatus and the electronic device is performed.

The motion detector 20 is a unit that receives biological signals according to the motion of a user. As the motion detector, an acceleration sensor, a gyro sensor, etc. can be used. Meanwhile, sensors, which are attached to a user's body and sense the biological signals, can be provided separately. The motion detector 20 receives the signals sensed through each sensor and transmits the received signals to a controller 30. Herein, the biological signals input to the motion detector 20 are signals input by the hand motion of the user, that is, signals generated at the time of making the motion in a specific direction or a specific form such as moving the user's hand in any one of up, down, left, and right directions, rotating the user's wrist left or right, etc. At this time, the motion detector 20 senses the signals and transmits the sensed signals to the controller 30.

The menu map implementing unit 40 arranges the virtual menu map 1 on a space based on the menu map information that is stored in the menu map information storing unit 10.

If the motion detector 20 senses the biological signals of the user, the controller 30 detects the motion information from the biological signals input by the motion detector 20 and transmits the detected motion information to the menu map implementing unit 40. The menu map implementing unit 40 processes the events corresponding to the motion information detected from the biological signals of the user among the menu map information that is the menu map information storing unit 10. At this time, the menu map implementing unit 40 processes the corresponding event to extract the control information for controlling the electronic devices 2 and transmits the extracted control information to the controller 30.

At this time, the controller 30 transmits the control information transmitted from the menu map implementing unit 40 to the corresponding electronic device 2 through the transceiver 50. Therefore, the corresponding electronic device 2 receiving the control information transmitted through the transceiver 50 performs the corresponding operation according to the received control information.

FIGS. 3A to 3C are a diagram exemplifying a virtual menu map implemented by a remote control apparatus using a menu markup language according to the present invention.

The menu map implementing unit 40 arranges the virtual menu map 1 within the area based on the menu map information stored in the menu map storing unit. This can be implemented in any one form of FIGS. 3A to 3C according to the biological signals generated by the user. FIG. 3 shows only some of the embodiments and thus, can of course provide the virtual menu map 1 in different forms.

FIGS. 4 to 6 are diagrams exemplified for explaining an operation of a remote control apparatus using a menu markup language according to the present invention. In detail, FIGS. 4 to 6 show embodiments of the menu map information that is defined using the menu markup language.

First, FIG. 4 shows route elements and child elements for designing the menu map using the menu markup language according to the present invention. FIG. 5 shows one embodiment of document type definition (hereinafter, referred to as ‘DTD’) that is defined for designing the menu map information. The ‘DTD’ defines the route elements and the child elements of FIG. 4.

Referring to FIGS. 4 and 5, ‘menuxml’, which is a route element that is defined in the menu markup language, can have a plurality of ‘devices’ that are a child element.

The ‘device’, which is an element that defines a specific device, can have ‘menu’ that is a child element. Herein, the specific device means the electronic device that is connected to the remote control device. At this time, the ‘device’ defines attributes such as a device name, a model name, a device ID(id), etc., including a MAC Address of the corresponding electronic device 2. Meanwhile, the ‘device’ defines an event (onload) attribute to be first processed when the corresponding device is first selected.

The ‘menu’, which is an element that defines a single menu for one device, can have a plurality of ‘items’ that are a child element. At this time, the ‘menu’ defines attributes such as a menu type, a menu title, and a menu ID (id) for the corresponding menu and a default of a button activated in loading the menu, a parent menu ID (parent), etc. Herein, the ‘id’ is defined by an integer value. Also, the ‘type’ is defined by selecting any one of a grid, a ring, and a pie. Further, the ‘default’ is defined by an integer value. At this time, the integer value is an order designated for the ‘item’ that is a child element.

Meanwhile, the ‘menu’ defines attributes such as an event (onspinleft) processed when the user rotates the wrist counter-clockwise and an event (onspinright) processed when the user rotates the wrist clockwise.

The ‘item’, which is an element that defines the menu buttons, does not have a child element. At this time, the ‘item’ defines attributes such as position values (index) of the corresponding buttons, IDs (fid) of each button, a button description (text). Further, the ‘item’ defines attributes such as recursive, skip, nomoveout, etc. required when controlling the menu by the hand motion. Herein, the recursive continuously selects the corresponding button whose attribute value is defined for the specific operation input by moving the hand up, down, left, and right. Also, the ‘skip’ skips the corresponding button whose attribute value is defined during the movement. In addition, the ‘nomoveout’ can be used in the buttons positioned at a corner and can drag the menu while being still in the corresponding menu when lowering the user's arm in the corresponding button whose attribute value is defined.

Meanwhile, the ‘item’ defines attributes such as an event (onclick) processed when the corresponding button is clicked and an event (onfocus) when the corresponding button is activated, and the like.

Of course, in addition to the event attributes as described above, the menu markup language defines the event attributes such as read (onload), left (onleft), (onright), right (onright), up (onup), down (ondown) and the like, which are generated by the hand motion of the user. The event attribute value can be described in a script form.

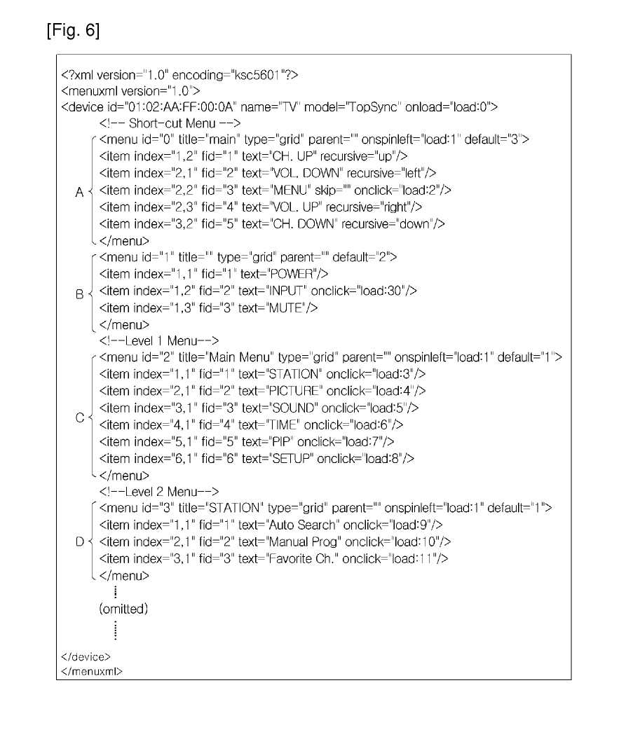

The menu map information for implementing the virtual menu map 1 is designed based on the DTD defined as described above. The embodiment thereof will be described with reference to FIG. 6.

FIG. 6 shows a portion of the menu map information described based on the DTD defined in FIG. 5 and describes a case where the electronic device 2 is ‘TV’.

Referring to FIG. 6, the ‘device’ defines ‘id’, ‘name’, ‘model’, etc., for the TV and defines the attribute value of the ‘menu’ that is a child element as an event to be first processed when selecting TV. At this time, the menu map implementing unit 40 processes the menu of the ‘A’ region that has the menu attribute value ‘0’, that is, id=“0”.

The ‘A’ region, which is a portion implementing a main screen in the virtual menu map 1, defines ‘CH. UP’, ‘VOL. DOWN’, ‘MENU’, ‘VOL. UP’ and ‘CH. DOWN’, respectively, which are the buttons of the main screen. At this time, the main screen is an example implemented in a grid type. The implementation example thereof will be described with reference to FIG. 3A.

Herein, while the menu of the ‘A’ region is processed, if the biological signal of any one of ‘up’, ‘down’, ‘left’, ‘right’, and ‘click’ is input, the motion detector 20 detects it and applies it to the controller 30, which transfers the corresponding motion information to the menu map implementing unit 40.

If the hand motion corresponding to ‘up’ is input, the menu map implementing unit 40 continuously selects and processes ‘CH. UP’ buttons defined in fid=“1” and if the hand motion corresponding to ‘left’ is input, the menu map implementing unit 40 continuously selects and processes ‘VOL. DOWN’ buttons defined in fid=“2”. Also, if the hand motion corresponding to ‘right’ is input, the menu map implementing unit 40 continuously selects and processes ‘VOL. UP’ buttons defined in fid=“4” and if the hand motion corresponding to ‘down’ is input, the menu map implementing unit 40 continuously selects and processes ‘CH. DOWN’ buttons defined in fid=“5”.

At this time, the menu map implementing unit 40 generates and outputs the control information corresponding to the selected menu button and the controller 30 transmits the control information output by the menu map implementing unit 40 to a ‘TV’ through the transceiver 50. Therefore, the ‘TV’ performs a corresponding function according to the control information received from the remote controller.

Meanwhile, if the hand motion corresponding to the ‘click’ is input, the menu map implementing unit 40 selects a ‘MENU’ button defined in fid=“3” and processes the menu of the ‘C’ region corresponding to the menu attribute value ‘2’, that is, id=“2”. At this time, the menu map implementing unit 40 processes the menu of the ‘C’ region and implements the main menu list corresponding to the ‘MENU’ button.

If ‘spinleft’ is input counter-clockwise by the rotation of the wrist while the menu of the ‘A’ region is executed, the menu map implementing unit 40 processes the menu of the ‘B’ region corresponding to the menu attribute value of ‘1’, that is, id=“1”.

The ‘B’ region is a region defining the menu buttons such as ‘POWER’, ‘INPUT’, ‘MUTE’, etc. and the implementation example thereof will be described with reference to FIG. 3A. Herein, while the menu of the ‘B’ region is processed, if the biological signal corresponding to any one of ‘left’, ‘right’, and ‘click’ is input, the motion detector 20 detects it and applies it to the controller 30, which transfers the corresponding motion information to the menu map implementing unit 40.

If the hand motions corresponding to the ‘left’ or ‘right’ are input, the menu map implementing unit 40 moves ‘POWER’, ‘INPUT’, and ‘MUTE’ buttons, respectively. Also, if the hand motion corresponding to the ‘click’ is input from any one button, the menu map implementation unit 40 processes the operation corresponding to the selected button.

In other words, if the ‘POWER’ button is selected, the menu map implementation unit 40 generates and outputs the control information corresponding to the turn on/off of a power supply of TV and the controller 30 transmits the control information output from the menu map implementing unit 40 to the ‘TV’ through the transceiver 50. Therefore, the ‘TV’ turns on/off the power supply according to the control information received from the remote controller. Meanwhile, if the ‘MUTE’ button is selected, the menu map implementing unit 40 generates and outputs the control information corresponding to the turn on/off of a sound canceling function of TV and the controller 30 transmits the control information output from the menu map implementing unit 40 to the ‘TV’ through the transceiver 50. Therefore, the ‘TV’ turns on/off the sound cancelling function according to the control information received from the remote controller.

Meanwhile, if the ‘INPUT’ button is selected, the menu map implementing unit 40 processes the menu (not shown) corresponding to the menu attribute value ‘30’, that is, id=“30”.

At this time, if the ‘spinleft’ is input by rotating the wrist counter-clockwise while the menu of other regions is executed, the menu map implementing unit 40 automatically processes the menu of the ‘B’ region.

The ‘C’ region is a portion that implements the menu map activated according to the selection of the ‘MENU’ button while the menu of the ‘A’ region is executed. The ‘STATION’, ‘PICTURE’, ‘SOUND’, ‘TIME’, ‘PIP’, and ‘SETUP’ buttons are each selected in the ‘C’ region. The implementation example thereof will be described with respect to FIG. 3C.

Herein, if the biological signal corresponding to any one of the ‘up’, ‘down’, and ‘click’ is input while the menu of the ‘C’ region is processed, the motion detector 20 detects it and applies it to the controller 30 so that the controller 30 transmits the corresponding motion information to the menu map implementing unit 40.

If the hand motion corresponding to the ‘up’ or ‘down’ is input, the menu map implementing unit 40 moves the ‘STATION’, ‘PICTURE’, ‘SOUND’, ‘TIME’, ‘PIP’, and ‘SETUP’ buttons, respectively. Further, if the hand motion corresponding to the ‘click’ in any one button is input, the menu map implementing unit 40 processes the operation corresponding to the selected button.

In other words, if the ‘STATION’ button is selected, the menu map implementing unit 40 processes the menu of the ‘D’ region that is the menu attribute value ‘3’, that is, id=‘3’ such that it implements the lower menu map of the ‘STATION’ menu. Likewise, if each of the ‘PICTURE’, ‘SOUND’, ‘TIME’, ‘PIP’, and ‘SETUP’ buttons is selected, the menu map implementing unit 40 processes the menu of the region corresponding to id=“4”, id=“5”, id=“6”, id=“7”, and id=“8”, such that it implements the lower menu map for the corresponding menu.

At this time, if the ‘spinleft’ is input by rotating the wrist counter-clockwise while the menu of the ‘C’ region is executed, the menu map implementing unit 40 automatically processes the menu of the ‘B’ region, such that the menu map shown in FIG. 3B is implemented.

The ‘D’ region is a portion that implements the lower menu map activated according to the selection of the ‘STATION’ button in the menu map implemented by the menu of the ‘C’ region. The ‘Auto Search’, ‘Manual Prog’, ‘SOUND’, and ‘Favorite Ch.’ buttons are each implemented. The implementation example thereof will be described with respect to FIG. 3C.

Herein, if the biological signal corresponding to any one of the ‘up’, ‘down’, and ‘click’ is input while the menu of the ‘D’ region is processed, the motion detector 20 detects it and applies it to the controller 30 so that the controller 30 transmits the corresponding motion information to the menu map implementing unit 40.

If the hand motion corresponding to the ‘up’ or ‘down’ is input, the menu map implementing unit 40 moves the ‘Auto Search’, ‘Manual Prog’, ‘SOUND’, and ‘Favorite Ch.’ buttons, respectively. Further, if the hand motion corresponding to the ‘click’ in any one button is input, the menu map implementing unit 40 processes the operation corresponding to the selected button.

In other words, if the ‘Auto Search’ button is selected, the menu map implementing unit 40 processes the menu (not shown) of the region that is the menu attribute value ‘9’, that is, id=‘9’ such that it implements the lower menu map of the ‘Auto Search’ menu. Likewise, if each of the ‘Manual Prog’, ‘SOUND’ and ‘Favorite Ch.’ buttons is selected, the menu map implementing unit 40 processes the menu (not shown) of the region corresponding to id=“10”, id=“11”, and id=“12”, such that it implements the lower menu map for the corresponding menu.

At this time, if the ‘spinleft’ is input by rotating the wrist counter-clockwise while the menu of the ‘D’ region is executed, the menu map implementing unit 40 automatically processes the menu of the ‘B’ region, such that the menu map shown in FIG. 3B is implemented.

As described above, the configuration and method of the foregoing embodiments is not restrictively applied to the remote controller using the menu markup language according to the present invention, but the configuration can be made by selectively combining the whole or a portion of each embodiment so as to variously change the embodiments.

Meanwhile, the menu map information used in the remote controller of the present invention can be implemented as a code readable by the processor on the recording medium readable by the processor included in the computer such as a mobile station modem (MSM). The recording medium readable by the processor includes all the kinds of recording apparatuses in which the data readable by the processor are stored. An example of the recording medium readable by the processor may include a ROM, a RAM, a CD-ROM, a magnetic tape, a floppy disk, an optical data storage device, etc. and can also be implemented in a carrier wave form such as transmission through the Internet. Also, the recording medium readable by the processor is distributed into the computer system connected to the network so that it can store the codes readable by the processor in a distributed manner and execute them.

As described above, although the present invention has been described with reference limited embodiments and accompanying drawings, the present invention is not limited to the embodiments and various changes and modification may be made by those skilled in the art. Therefore, the scope of the present invention should not be limited to the above-described embodiments and should be defined by the appended claims and their equivalents.

1. A remote control apparatus transmitting control information corresponding to motion information of a user to electronic devices, comprising:
a menu map information storing unit that stores a menu map information defined by a menu markup language (Menu XML) in an extensible markup language (XML) format in order to implement a virtual menu map within an area for controlling the electronic devices; and
a menu map implementing unit that implements the virtual menu map according to the menu map information stored in the menu map information storing unit, extracts control information corresponding to the motion information of the user from the menu map information, and transmits the extracted control information to the electronic devices.

2. The remote control apparatus according to claim 1, wherein the menu map markup language includes a route element ‘menuxml’ defined to inquiry the plurality of electronic devices.

3. The remote control apparatus according to claim 1, wherein the menu markup language further comprises elements that define the corresponding electronic devices.

4. The remote control apparatus according to claim 3, wherein the elements defining the electronic devices includes at least one of id attribute, name attribute, and model attribute regarding the corresponding electronic devices.

5. The remote control apparatus according to claim 1, wherein the menu markup language further comprises elements defining menus regarding the corresponding electronic devices.

6. The remote control apparatus according to claim 5, wherein the elements defining the menus includes at least one of id attribute, title attribute, type attribute, default attribute, and parent attribute regarding the corresponding menus.

7. The remote control apparatus according to claim 1, wherein the menu markup language further comprises elements defining menu buttons configuring the corresponding menus.

8. The remote control apparatus according to claim 7, wherein the elements defining the menu buttons includes at least one of index attribute indicating a position, id attribute, and text attribute indicating button description regarding the corresponding menu buttons.

9. The remote control apparatus according to claim 7, wherein the elements defining the menu button further comprises attribute for controlling the corresponding menu buttons according to the motion information of the user

10. The remote control apparatus according to claim 9, wherein the attribute for controlling the menu buttons is at least one of recursive attribute, skip attribute, and nomoveout attribute regarding the corresponding menu buttons.

11. The remote control apparatus according to claim 1, wherein the menu markup language defines an event attribute according to the motion information of the user.

12. The remote control apparatus according to claim 11, wherein the event attribute is at least one of onload, onclick, onleft, onright, onup, ondown, onspinleft, and onspinright.

13. The remote control apparatus according to claim 11, wherein the menu map information is configured to have a level structure including a upper menu and a lower menu,
the upper menu and the lower menu have a connection structure according the event attribute.

14. The remote control apparatus according to claim 1, wherein the motion information of the user is the hand motion information of the user.
